(19) United States
(12) Patent Application Publication
(10) Pub. No.: US 2018/0237342 A1
(43) Pub. Date: Aug. 23, 2018

(54) Binder Composition For Use With Aggregates

(71) Applicant: METSSL LTD, Cosham, Portsmouth, Hampshire (GB)

(72) Inventor: Sebastian LOVE, Farnham (GB)

(73) Assignee: METSSL LTD, Cosham, Portsmouth, Hampshire (GB)

(21) Appl. No.: 15/753,089

(22) PCT Filed: Jun. 17, 2015
(86) PCT No.: PCT/IB2015/054580

§ 371 Date: Feb. 15, 2018

(51) Int. Cl. C04B 28/26; C04B 28/14; C04B 28/08

(52) U.S. Cl. CPC C04B 28/26; C04B 28/08; C04B 28/14

(57) ABSTRACT

A binder composition substantially comprising between 68.7 and 93% by weight cement, between 0 and 20% by weight additional silicate bearing material, and between 4 and 20% by weight gypsum. Preferably the binder composition substantially comprises between 68.7 and 88.7% by weight cement, between 0 and 15% additional silicate bearing material, and between 4 and 20% by weight gypsum.

### FIELD OF THE INVENTION

This invention relates to binders and binder compositions, as well as mixture of said binders with other materials and a system and method for using the aforesaid binders and binder compositions.

### BACKGROUND OF THE INVENTION

Binders can be mixed with sub-soil and recycled/primary aggregates to form Stabilised/Hydraulically Bound Materials that can be used as General Fill, Capping, Sub-Base and Base layers in Earthworks and/or Highways and Footpath construction. These Stabilised/Hydraulically Bound Materials are manufactured/produced to BSEN 14227 parts 1 to 13, the Specification of Highways Works 800 and 600 series, the Specification for Road Openings in the Highways 2010 3^{rd} Edition and any future modification or replacement such standards thereof. It is an object of the invention to provide an improved binder which provides enhanced material properties in the final product.

### Prior Art

Japanese Patent Application JP-A-2011073940 (Sumitomo Osaka Cement Company) discloses a cement composition that is capable of spontaneously disintegrating under water after a specified time period.

Japanese Patent JP-B-2513154 (Mitsubishi Materials Corporation) discloses a quick setting composition with a long life which uses slag from stainless steel and anhydrous gypsum.

Japanese Patent Application JP-A-19960625 (Kuoci-I Kuo) describes lightweight cement comprising clinker, aluminium stone gypsum and fly ash.

Japanese Patent JP-B-19900412 (Mitsubishi Mining & Cement Company) teaches a cheap and mouldable cement mixture includes blended metallurgical slag, anhydrous gypsum and a setting retarder.

An aim of the present invention is to provide an improved dry binder mix which does not flow.

Another aim of the present invention is to provide a dry-mix binder that is suitable for use with a range of different soils in order to facilitate in-situ preparation of products.

A further aim of the present invention is to provide an improved binder mix that is suitable for use with a range of soil types.

### Statement of the Invention

According to one aspect of the invention is provided a binder composition substantially comprising: between 68.7% and 93% by weight cement; between 0% and 20% by weight additional silicate bearing material; and between 4% and 20% by weight gypsum.

An important advantage of the present invention over existing wet-mix products, is that wet-mix products have defined compositions which differ significantly from the end products produced. Water is not requires when using the present binders, as they are intended to be mixed in situ with available sub-oil, including clays, sands, gravels and silts, to produce an end product. Subsoil ground strata differs significantly depending on the geographical region. The aforementioned wet-mixes do not use subsoil as this would tend to weaken and slow the curing time of each end product.

According to another aspect of the invention is provided a system for preparing a binder composition including: two or more storage silos, an auger which delivers material from each silo according to a predetermined set of control instructions to a mixing drum, the materials are mixed and blended together in the drum and transported to a storage hopper, from where a specified amount of the mixed material is discharged into a bag and the bag is weatherproofed against ingress of moisture

Preferably the composition of constituents for the binder composition comprises: between 68.7% and 88.7% by weight cement; between 0 and 15% additional silicate bearing material; and between 4 and 20% by weight gypsum.

The binder may comprise between 75.7% and 81.7% by weight cement. The binder comp composition may comprise between 77.7 and 79.7% by weight cement.

The binder composition may comprise between 5.3 and 13.3 by weight additional silicate bearing material. The binder composition may comprise between 7.3 and 11.3% by weight additional silicate bearing material.

The binder mixture may comprise between 8.3 and 10.3% by weight additional silicate bearing material. The binder composition may comprise between 8 and 16% by weight gypsum and preferably between 11 and 13% by weight gypsum.

The composition may comprise between 86.4% to 92.4% by weight cement, between 3.6 and 5.6% by weight additional silicate bearing material and between by weight 4.5 and 7.5% gypsum. It may preferably comprise between 86.4% to 92.4% by weight cement, between 3.6 and 5.6% additional silicate bearing material and between 4.5 and 7.5% gypsum.

The binder may comprise preferably between 88.9 to 90.9% by weight cement, between 4.1 and 5.1% by weight additional silicate bearing material and between 5.5 and 6.6% by weight gypsum.

Also the wet-mixes have the same end product composition each time whereas the present invention may differs significantly with each different subsoil ground strata which is used with the binder.

The additional silicate bearing material comprises one or more of disodium metasilicate, sodium metasilicate pentahydrate, silicon dioxide, tricalcium silicate, dicalcium silicate, calcium silica hydroxide, calcium alumina silica hydroxide, or a combination thereof.

The additional silicate bearing material may be provided by silica fume, blast furnace slag, metakaolin, fly ash or a combination thereof.

Advantages of the present invention, over the aforementioned binders and cements are that the present binders are used in non-flowable products. That is to say, the present binders require compaction and grading to a finished level in the structure or application where they are being used. A wet-mix does not require compaction and is self-levelling in nature: that is, it does not require any mechanical grading to acquire the finished level of the intended structure in which it is used.

Another important difference is wet-mix products require the addition of water. The present mixtures do no generally require the addition of water. This can be a great benefit where resources are limited.

A further important advantage with the present invention over some prior art mixtures is that the present invention cures only once compacted, whereas many prior art mixtures cure/set very quickly.

Preferred embodiments of the present invention, when used with the subsoil to produce an end product will only cure after they are compacted. When the binders are mixed with the subsoil, the end product remains usable for several days and in some cases more than a week.

Wet-mixes are typically used in place of concrete. The end products produced with the present binders, in combination with a subsoil, are intended to be used in place of stone aggregates and not concrete. A wet-mix material typically would not be used in the same applications as the present binders because it would be impractical and not cost effective.

Benefits of the invention for the end-user include:
Reduction of material sent to landfill
Reduction in use of quarried aggregates
Reduced carbon footprint of products produced
Reduced carbon emissions
Reduced lorry movements
Reduced social disruption
Increased use of recycled products
Faster turnaround of earth works

In a further aspect of the invention there is provided a binder composition substantially comprising: between 50% and 80% by weight cement; between 10 and 40% by weight additional silicate bearing material; and between 4% and 20% by weight gypsum, wherein said additional silicate bearing material includes blast furnace slag.

The additional silicate bearing material comprises a mixture of slag and one or more of disodium metasilicate, sodium metasilicate pentahydrate, silicon dioxide, tricalcium silicate, dicalcium silicate, calcium silica hydroxide, calcium alumina and silica hydroxide.

The additional silicate bearing material comprises a mixture of slag and one or more of: silica fume, metakaolin, and fly ash.

The wherein said proportion of slag may between 14 and 34%. The slag may be ground/granulated blast furnace slag. The gypsum comprises a mixture of fine casting plaster and recycled plaster/plasterboard.

The casting plaster in the above compositions preferably has a particle size less than 270 microns diameter.

All proportions given are by weight.

In a yet further aspect there is provided a construction material including a binder or product formed from inclusion of a binder. The compositions may be used in filling or capping of base or sub-base layers in earthworks, highways or footpaths.

### BRIEF DESCRIPTION OF THE FIGURES

FIG. 1 is a flow diagram that illustrates key stages in production of mixtures of binder compositions;

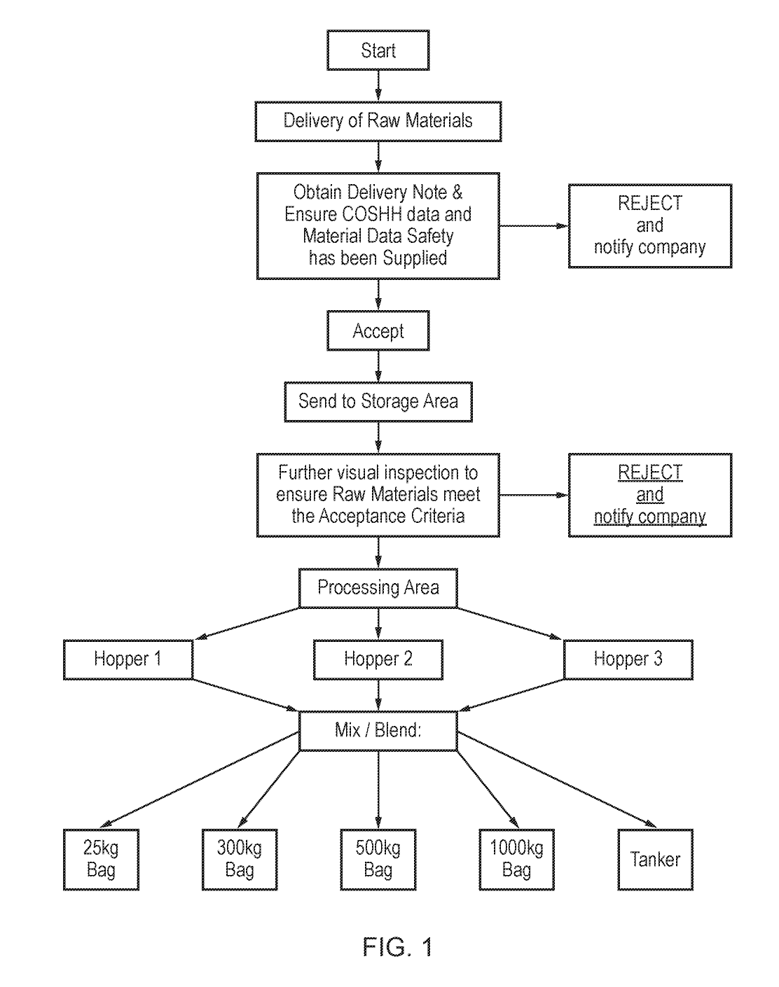

FIG. 2 is an overall diagrammatical view of one example of a mixing plant showing hoppers;

FIG. 3 is an overall diagrammatical view of another example of a mixing plant; and

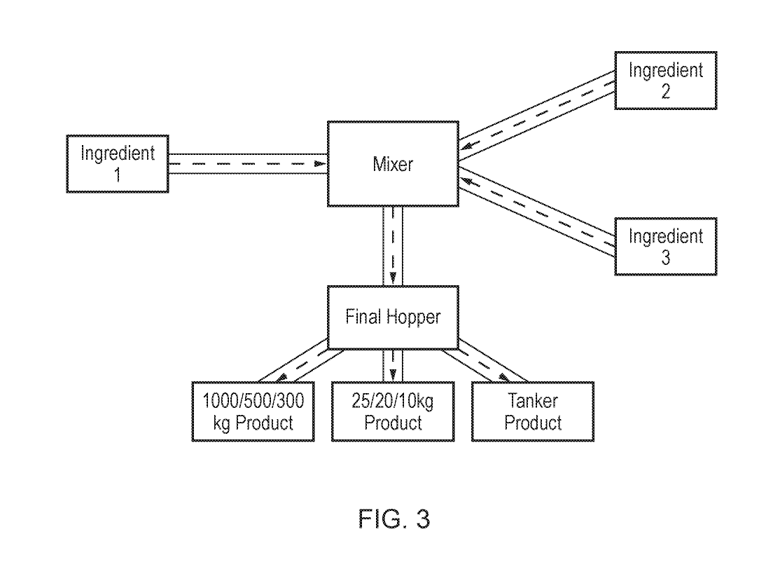

FIG. 4 is an overall view of a bagging plant and system for producing the binder.

### DETAILED DESCRIPTION OF PREFERRED EMBODIMENTS OF THE INVENTION

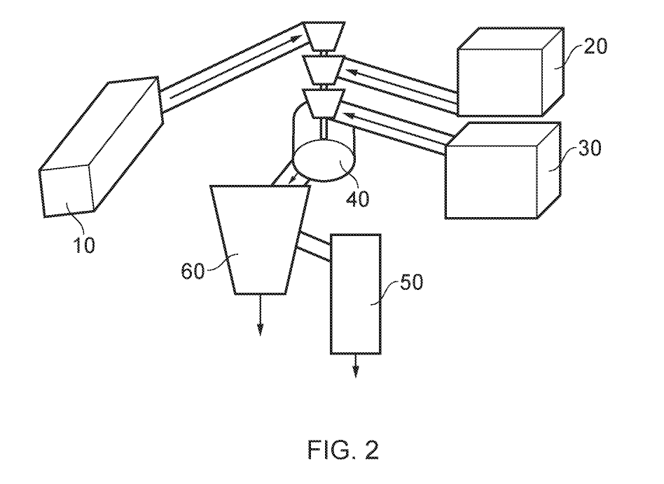

Referring to the Figures, which illustrate the plant and equipment that is used in producing the mixture, there is shown in FIG. 2 a cement hopper 10 which feed into a mixer 40. Hopers 20 and 30 contain other material, such as disodium and gypsum and/or silicate fume and/or metakaolin and/or pulverised fuel ash (PFA), and/or casting plaster. The plant and equipment, shown in FIG. 2 is used to mix constituent materials in desired ratios in order to achieve binder mixtures of described properties as described below.

### Example 1

One example of a binder composition comprises 78.7% by weight cement, 9.3% by weight disodium metasilicate and 12% fine casting plaster.

The cement may be any selected from hydraulic cements or Portland cements. The hydraulic cements may be mixtures of fine ground limestone, alumina, and silica. These constituents react and start to cure with addition of water and then in addition to this (in some cases) compaction. During these processes a Calcium Silica Hydroxide gel is formed, calcium hydroxide and additional cementitious reactions. Aluminous cements typically contain at least 30%-35% alumina.

Preferably the cement is Portland cement such as ordinary Portland cement. The raw materials required to produce Portland cements are composed of calcium carbonate, alumina, silica, and iron oxide (as tetracalcium aluminoferrate), tricalcium aluminate, tricalcium disodium metasilicate, and dicalcium silicate.

The cement is preferably ordinary Portland cement (CEM1). Alternatively any other type of cement, such as CEM2, CEM3, CEM4 and CEM5 may be used. Gypsum is sulphate mineral composed of calcium sulfate dihydrate, Gypsum plaster, or plaster of Paris, and is typically produced by heating gypsum.

### Example 2

According to a general example the binder composition substantially comprises between 68.7% and 88.7% by weight cement; between 5.3 and 13.5 5% disodium metasilicate; and between 4 and 20% gypsum.

Preferably the composition comprising between 75.7 and 81.7% by weight cement; between 7.3% and 11.3% disodium metasilicate; and between 8% and 16% gypsum.

In a further preferred example preferably the composition comprises between 77.7 and 79.7% by weight cement; between 8.3% and 10.3% disodium metasilicate and between 10% to 14% gypsum.

As an alternative to disodium metasilicate, other silicate bearing compounds may be used such as silica fume, metakaolin, blast furnace slag and fly ash.

When added to water cement reacts and forms a hard paste called Calcium Silica Hydroxide (approximately 75%) the other product/compound that is produced is Calcium Hydroxide (approx 25%). Disodium Metasilicate is a different form of silicate to for example silicon dioxide, but when added to the cement will react with the 25% of Calcium Hydroxide and produce additional cementitious and strength gaining properties.

Disodium Metasilicate is therefore a different compound of silica than that contained in cement but by adding it to the mix it increases/adds to the strength gaining properties of the product and increases the beneficial effects.

In still a further refined embodiment the percentage weight of the constituents varies between +/−1% of the point composition given in the first example.

The amount of disodium metasilicate may be varied relatively widely according to application and may comprise between 0 and 15% of the binder composition.

The gypsum constituent may be gypsum, fine casting plaster. Preferably the particle size is less than 770 microns diameter, and preferably less than 260 microns diameter.

In a preferred embodiment the gypsum component comprises recycled plaster or plasterboard.

In alternative embodiments the gypsum component may comprise a mixture of casting plaster and recycled plaster material such as recycled plasterboard.

In some applications, the proportion of cement may be increased and correspondingly, the proportion of disodium metasilicate and gypsum is reduced.

In a specific example, the binder may comprise 89.4% by weight cement, 4.6% disodium metasilicate and 6% gypsum.

In a general example of binder for such applications, the cement content is between 86.4% to 92.4% by weight cement, between 3.6 and 5.6% disodium metasilicate and between 4.5 and 7.5% gypsum.

Preferably the range varies +/−1% from the specific point example.

### Example 3

In a further aspect of the invention is provided a binder composition comprising by weight; 74.8% Ordinary Portland Cement; 13.2% silica fume; and 12% gypsum.

The cement proportions may lie in the range 72.8% to 76.8%. The silica fume content may vary between +/−5%, preferably between 11.7% and 14.7%. The gypsum content may vary between 10.5 and 13.5%. The gypsum may be fine casting plaster or recycled plaster board.

Silica fume is often referred to alternatively as microsilica and can be provided as an ultra-fine powder with the average particle diameter of 150 nm and is also referred to as precipitated silica; fumed silica; gel silica; colloidal silica; silica flour and silica dust. It is typically 100 times smaller than average cement particle. When OPC reacts with water, silica fume reacts with 25% calcium hydroxide.

Silica fume is the by-product of producing silicon metal or ferrosilicon alloys. It generally comprises amorphous silicon dioxide 85%.

The silica fume may be replaced by fly ash, preferably pulverised, ground granulated blast furnace slag, metakaolin or disodium metasilicate.

### Example 4

In a further aspect of the invention is provided a binder composition similar to the one above, but which includes the addition of sodium metasilicate pentahydrate. A typical composition may by weight 66.9% Ordinary Portland Cement; 11.8% silica fume; 9.3% sodium metasilicate pentahydrate; 12% gypsum.

The cement proportions may lie in the range 60% to 75%.

The gypsum content may vary between +/−5%, preferably between 10.5 and 13.5%.

The gypsum may be fine casting plaster or recycled plaster board.

The sodium metasilicate pentahydrate proportion may vary from 0 to 20%, preferably 9 to 15% and preferably 11 to 13%.

The silica fume proportion may vary from 0 to 20% preferably 5 to 15% and preferably 7.8% to 10.8%.

The silica fume may be replaced by fly ash, preferably pulverised or slag.

The sodium metasilicate pentahydrate may be replaced by disodium metasilicate, silica fume, metakaolin, blast furnace slag or fly ash.

### Example 5

In a further aspect of the invention is provided a binder composition comprising by weight 66.9% Ordinary Portland Cement; 11.8% metakaolin; 9.3%, sodium metasilicate pentahydrate and 12% gypsum.

The sodium metasilicate pentahydrate may be replaced by disodium metasilicate, silica fume, metakaolin, blast furnace slag or fly ash.

The alternatives to metakaolin may be disodium metasilicate; silica fume; ground granulated blast furnace slag and pulverised fly ash.

The gypsum may be fine casting plaster or recycled plaster board. The component proportions may be varied by +/−3%, preferably +/−1.5%. The cement and/or metakaolin proportions may vary by +/−10%.

Metakaolin is a pozzolanic product and provides a pozzolanic reaction in the binder which can continue between 7 to 28 days. The OPC in the binder reacts with water to form 75% CSH gel and the calcium hydroxide (hydrated lime) in the cement reacts with the metakaolin to produce additional cementitious reactions.

### Example 6

In a further aspect of the invention is provided a binder composition comprising by weight 74.8% Ordinary Portland Cement, 13.2% metakaolin, and 12% gypsum.

The component proportions may be varied by +/−3%, preferably +/−1.5%.

The gypsum may be fine casting plaster or recycled plaster board.

The cement and metakaolin proportions may vary by +/−18% preferably +/−10%, and further preferably +/−5%.

The metakaolin may be replaced with silica fume, disodium metasilicate, blast furnace slag or fly ash.

### Example 7

In a further aspect of the invention is provided a binder composition comprising by weight: 55.09% Ordinary Portland cement; 23.61% (blast furnace) slag; 9.3%, sodium metasilicate pentahydrate; and 12% gypsum. The slag may be ground granulated blast furnace slag (GGBFS), which is a by-product of iron and steel making—generally pig iron cycled plaster board.

The component proportions may be varied by +/−3%, preferably +/−1.5%. The gypsum may be fine casting plaster or recycled plaster board, and the proportion may vary from 8 to 16%. The cement and/or slag proportions may vary by +/−24%, or by +/−10%, preferably +/−5%.

The sodium metasilicate pentahydrate may be replaced by disodium metasilicate, silica fume, disodium metasilicate, metakaolin, blast furnace slag or fly ash. The addition of slag helps protect concrete against sulphate and chloride attack. Any grade such as grades 80, 100, or 120 may be used. Preferably the highest, 120, is used. The slag may be replaced with silica fume or fly ash.

Brief reference will now be made to the techniques of production of three of the aforementioned mixtures and with reference to the Figures.

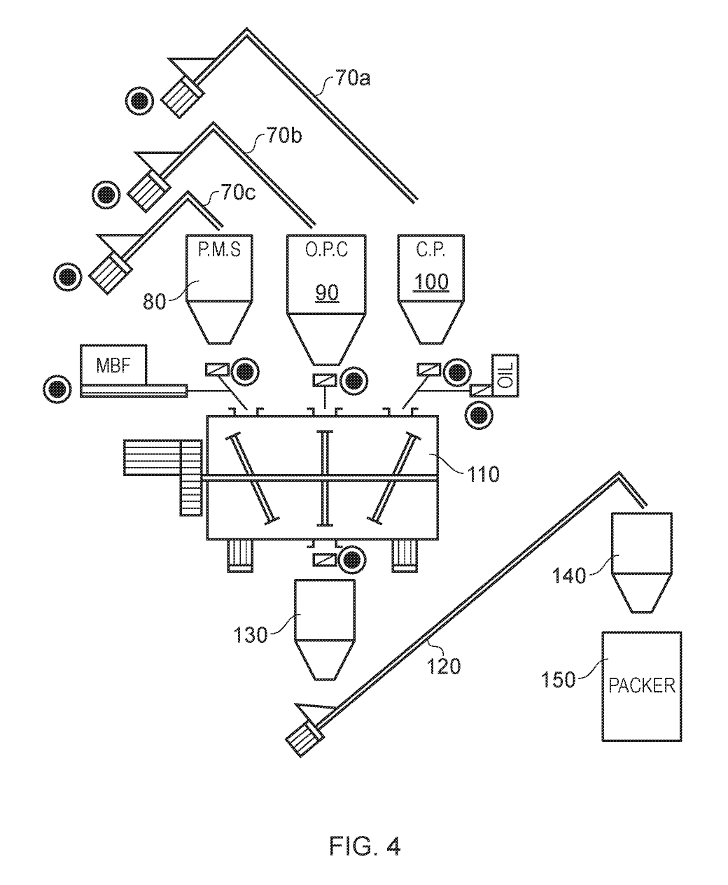

Referring to FIGS. 4 and 5, materials and products are loaded into silos 10. From the silos 10 mixtures and materials are fed by augers into 3 separate holding hoppers 20, 22 and 24 to a predetermined weight. The mixtures and materials are then released into a mixing drum 130 where mixing occurs in a dry state. The materials are added at a specific rate and mass into a mixing drum. These materials are then blended/mixed together.

Referring to FIG. 4, the 3 holding hoppers 80, 90 and 100 have reached their predetermined weight of the materials, the constituent materials fed via augers 70a, 70b and 70c are then released into mixing drum 110. The constituent ingredients are mixed for a minimum of 2 minutes and ideally less than a maximum of 4 minutes. After the designated mix time has been completed, the final mixture is transferred into final product holding hopper 130.

After the relevant mixing time in accordance with desired end properties, the now blended binder mixture is fed by auger 120 into a final product hopper 140. The relevant binder mixture is then discharged into relevant bulk bags (not shown) at predetermined weights by a packer 150. The binder product then has a waterproof hood shrink-wrapped onto it to make sure it is protected from weather and moisture. It is then transported to the storage area for dispatch.

One of the example binder mixtures has a shelf life, when neat, of 3 months. As the main constituent is hygroscopic it is advised to check it prior to use.

The binder has a shelf life, when neat, of 3 months. As the main constituent is hygroscopic (meaning it absorbs any moisture present), it is worthwhile after 3 months to have its strength tested

### Process Instructions

The invention is of particular benefit when used with high voltage (in excess of 50 kiloVolts) subterranean cables as it has ideal thermal conductivity and offers good mechanical strength so that it is thermally and mechanically stable when in close proximity with the high voltage subterranean cables which can reach elevated temperatures.

The invention has been described by way of examples only and it will be appreciated that variation may be made to the above-mentioned embodiments and mixtures without departing from the scope of invention. Therefore, the foregoing are considered as illustrative examples only of mixtures of materials, methods of production and methods of application of the aforesaid materials falling within the scope of the invention.

Further, since numerous modifications and changes will readily occur to those skilled in the art, it is not desired to limit the invention to the exact construction and operation shown and described, and accordingly, suitable modifications and equivalents are considered to fall within the scope of the claims appended hereto.

1. A binder composition substantially comprising: between 68.7% and 93% by weight cement; between 0% and 20% by weight additional silicate bearing material; and between 4% and 20% by weight gypsum.

2. A binder composition as claimed in claim 1 substantially comprising: between 68.7% and 88.7% by weight cement; between 0% and 15% additional silicate bearing material; and between 4% and 20% by weight gypsum.

3. A binder composition as claimed in claim 2 comprising between 75.7% and 81.7% by weight cement.

4. A binder composition as claimed in claim 2 comprising between 77.7% and 79.7% by weight cement.

5. A binder composition as claimed in claim 2 comprising between 5.3% and 13.3% by weight additional silicate bearing material.

6. A binder composition as claimed in claim 2 comprising between 7.3% and 11.3% by weight additional silicate bearing material.

7. A binder composition as claimed in claim 2 comprising between 8.3% and 10.3% by weight additional silicate bearing material.

8. A binder composition as claimed in claim 2 comprising between 8% and 16% by weight gypsum.

9. A binder composition as claimed in claim 2 comprising between 11% and 13% by weight gypsum.

10. A binder composition as claimed in claim 1 comprising between 86.4% to 92.4% by weight cement, between 3.6% and 5.6% by weight additional silicate bearing material and between by weight 4.5% and 7.5% gypsum.

11. A binder composition as claimed in claim 10 comprising between 86.4% to 92.4% by weight cement, between 3.6% and 5.6% additional silicate bearing material and between 4.5% and 7.5% gypsum.

12. A binder composition as claimed in claim 10 comprising between 88.9% to 90.9% by weight cement, between 4.1% and 5.1% by weight additional silicate bearing material and between 5.5% and 6.6% by weight gypsum.

13. A binder composition as claimed in claim 1 wherein said additional silicate bearing material comprises one or more from the group comprising: disodium metasilicate, sodium metasilicate pentahydrate, silicon dioxide, tricalcium silicate, dicalcium silicate, calcium silica hydroxide and calcium alumina silica hydroxide.

14. A binder composition as claimed in claim 1 wherein said additional silicate bearing material is provided by silica fume, blast furnace slag, metakaolin, fly ash or any combination thereof.

15. A binder composition substantially comprising: between 50% and 80% by weight cement; between 10% and 40% by weight additional silicate bearing material; and between 4% and 20% by weight gypsum, wherein said additional silicate bearing material includes furnace slag.

16. A binder composition as claimed in claim 15 wherein said additional silicate bearing material comprises a mixture of slag and one or more of disodium metasilicate, sodium metasilicate pentahydrate, silicon dioxide, tricalcium silicate, dicalcium silicate, calcium silica hydroxide, calcium alumina and silica hydroxide.

17. A binder composition as claimed in claim 15 wherein said additional silicate bearing material comprises a mixture of slag and one or more of: silica fume, metakaolin, and fly ash.

18. A binder composition as claimed in claim 15 wherein said proportion of slag is between 14% and 34%, preferably between 20% and 28%.

19. A binder composition as claimed in claim 15 wherein said gypsum comprises a mixture of: fine casting plaster.

20. (canceled)

21. A binder composition as claimed in claim 19 wherein said casting plaster has a particle size less than 270 microns diameter.

22-33. (canceled)
